(19) United States
(12) Patent Application Publication
(10) Pub. No.: US 2007/0156851 A1
(43) Pub. Date: Jul. 5, 2007

(54) Collaborative help system

(75) Inventor: Osman Talha Tasci, Rochester, NY (US)

Correspondence Address: Anthony L. Miele;Miele Law Group, Suite 306, 2 Summer Street, Natick, MA, 01760, US

(73) Assignee: Xerox Corporation

(21) Appl. No.: 11/322,635

(22) Filed: Dec. 30, 2005

(51) Int. Cl. G06F 15/16

(52) U.S. Cl. 709/219

(57) ABSTRACT

Apparatus are provided including a networking element to connect a user computer with an expert computer. A changing set of help topics is provided indicating topics for which a user requests help or for which an expert provides help. A help topic set modifier is provided to modify the changing set of help topics.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

The present disclosure relates to online communications systems, and more particularly, to a support-related online communications system.

### BACKGROUND

On line communications system include e-mail infrastructures (for example, Microsoft Outlook™), web-base collaboration tools (for example, Microsoft NetMeeting) and remote support infrastructures (for example, the Citrix® GoToAssist™ product). Support-related online communications systems generally connect users (help requesters) with experts (help providers) through an online connection—e.g., via one or a combination of local, wide area, and direct network connections (including any type of network technology—e.g., the Internet, a proprietary intranet/extranet technology, PSTN, etc.).

A support-related online communications system may, for example, help a user find an expert on a particular application software product. For example, the user may need an expert's help with a given software application. The Citrix® GoToAssist™ product allows technical support personnel to remotely access customer computers and secure data centers to resolve the computer's IT issues.

### SUMMARY OF THE DISCLOSURE

One embodiment of the disclosure is directed to an improved support-related online communications system that provides users and/or experts with more control over the types of help topics that can be addressed by a given expert or that are required by a given user.

In accordance with one embodiment, apparatus are provided. A network element is provided to connect a user computer with an expert computer. A changing set of help topics is provided. A help topic set modifier is provided to modify the help topics in the changing set. The networking element may include a user computer network connection, a user computer web browser, an expert computer network connection, and/or an expert computer web browser. In addition, or in the alternative, the networking element may include a help server.

The changing set of help topics may include a set of user help topics unique to a given user and/or a set of expert help topics unique to a given expert. More specifically, the help topics can include a list of applications. The set of help topics can be stored in a memory of a user computer, in a memory of an expert computer, and/or in expert and user profile databases of a help server. The help topic set modifier may include a prompt interface element prompting a user, via a computer screen interface on the user computer, to input a help topic desired by the user. In addition, or in the alternative, the help topic set modifier may include for example, a sweeper, remote from the user computer, to sweep the user computer to ascertain configuration information.

### BRIEF DESCRIPTION OF THE DRAWINGS

Embodiments of the disclosure are further described in the detail description which follows, by reference to the noted drawings in which like reference numerals represent similar parts throughout the several views of the drawings, and wherein:

FIG. 1 is a block diagram of a collaborative help system;

FIG. 2 is a flow chart of an expert process;

FIG. 3 is a schematic block diagram of part one of a front end of the collaborative help system;

FIG. 4 is a schematic block diagram of part two of the illustrated front end; and

FIG. 5 is block diagram of the back end of the illustrated collaborative help system.

### DETAILED DESCRIPTION

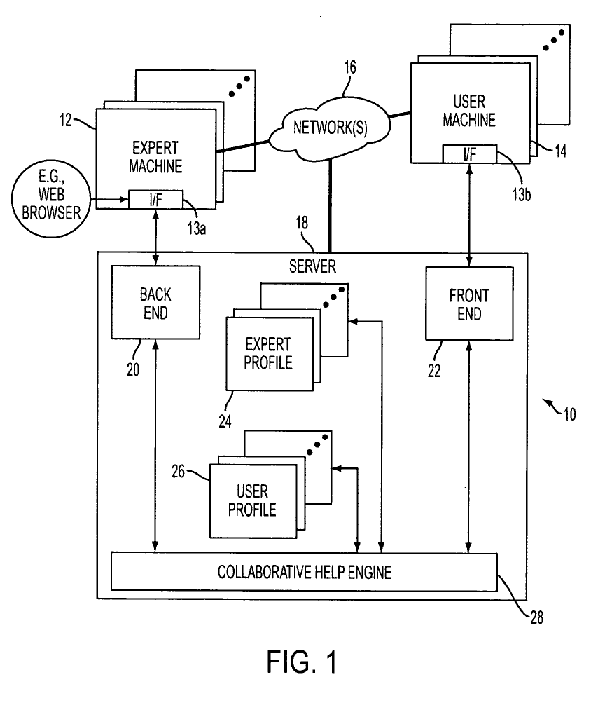

Referring now to the drawings in greater detail, FIG. 1 shows a block diagram of a collaborative help system 10. The illustrated system 10 includes at least one help server 18 connected through online connections to a plurality of expert machines 12 and user machines 14. As shown in FIG. 1, the help server 18 may be connected to the machines 12 and 14 via one or more networks 16. Each expert machine 12 includes an interface 13a, and each user machine 14 includes an interface 13b. The illustrated interfaces 13a and 13b may include, for example, web browsers. In embodiments, expert machines 12 and user machines 14 may, e.g., include any general or special purpose computer (e.g. personal computers, laptops, workstations, or smaller computer devices).

The illustrated collaborative help system 10 includes one or more changing sets of help topics. In the specific embodiment illustrated, the one or more sets of help topics include sets of data provided in expert profiles 24 and user profiles 26. More specifically, the help server 18 may include a plurality of expert profiles 24 corresponding to respective ones of expert machines 12, which may be stored in expert profile databases of help server 18. Similarly, a plurality of user profiles 26 may be provided which correspond respectively to user machines 14, and which are stored in one or more user profile databases of help server 18.

The one or more sets of help topics may include help topics which are specified by a given user using one of the user machines 14, as well as information concerning the types of help topics for which a given expert will provide help, which the expert can specify via his or her expert machine 12. Accordingly, the set of help topics may include a set of user help topics unique to a given user, and may also include a set of expert help topics unique to a given expert. In the embodiment illustrated, the help topics include listed applications for which a given user may require help or for which a given expert may be able to provide help. The help topic information associated with a user or an expert may be accessed by and stored in each of the expert machines 12 and user machines 14, for example, via the use of an interface 13a, 13b. Specifically, the interfaces 13a, 13b may each include a web browser.

The illustrated help server 18 includes a back end 20 which for interfaces with the expert machines 12, and a front end 22 which interfaces with user machines 14.

The collaborative help engine 28 facilitates access to a data in each of the expert and user profiles 24 and 26 by either of back end 20 and front end 22. In addition, collaborative help engine 28 may, for example, provide other functionality for help server 18, such as allowing administrators to access the help server 18.

The expert machine back end 20 may perform a process whereby an expert logs in and receives certain information regarding a help request, and is also able to provide information regarding the types of help that expert is willing to provide. In addition, back end 20 may facilitate the interaction between a given expert via an expert machine 12 with a given user via a user machine 14.

Similarly, front end 22 allows a user to interact with help server 18, to provide information regarding help subjects with which it is interested, to choose applications that are at issue, and to provide key words regarding the type of help requested by the user. In addition, the front end 22 may allow a user, via a user machine 14, to view the available experts, as well as experts previously used by the user, and to select an expert.

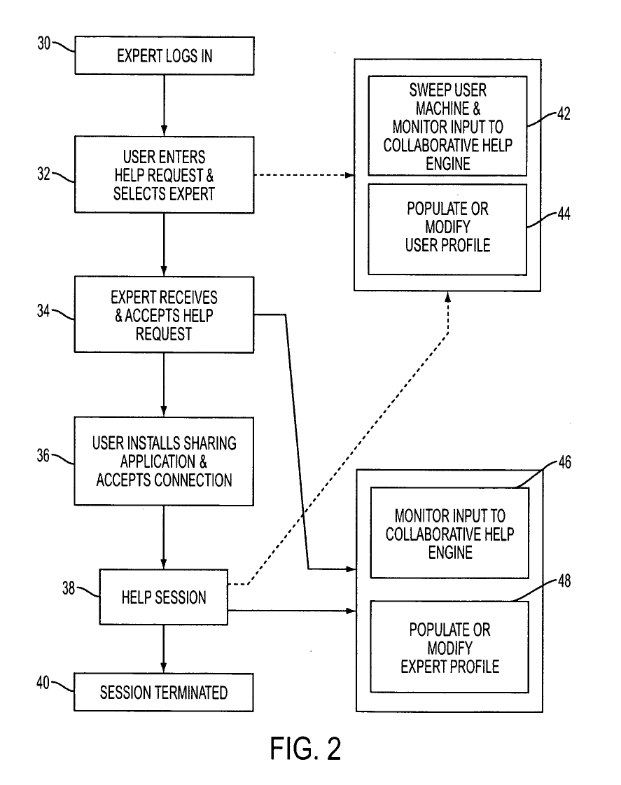

FIG. 2 provides a flow chart of a help process. As illustrated in FIG. 2, in an initial act 30, an expert logs in to the help server 18 via his or her expert machine 12 through its interface with back end 20. At act 32, the user enters a help request and selects an expert. This is done by the user through the use of his or her user machine 14 which interfaces with the help server 18 via front end 22. When the user enters the help request and selects an expert, the collaborative help engine 28 may, at acts 42 and 44, sweep the user machine and/or monitor the input to the collaborative help engine of the user at act 42, and populate or modify the user profile at act 44.

After act 32, at act 34, the expert receives, on his or her expert machine 12, the help request, and accepts the help request, by interacting with his or her user interface on the expert machine 12. When the expert receives and accepts a help request at act 34, the expert machine may be swept by the collaborative help engine and/or the expert machine input by the expert may be monitored, for information regarding the types of expert advice or help the expert provides to users. In addition, the expert profile for that given expert may be populated or modified at act 48.

After act 34, the process proceeds to act 36, where the user, through use of his or her user machine 14, installs a sharing application on the user machine 14 and accepts a connection by the expert via his or her expert machine 12 to the user machine 14. Examples of sharing applications include the PC Anywhere, Citrix Remote User Applications, and Windows Remote User Applications.

After act 36, act 38 is performed where a help session occurs. Here, a user and expert may interact with each other, while the expert takes control at certain points in time of the user's machine to help the user solve his or her problem. At some point during help session 38, the process may return to acts 42 and 44 as well as to acts 46 and 48. Accordingly, additional sweeps of the expert and user machines as well as monitoring of input of those machines may be performed by the collaborative engine 28. In accordance with such monitoring and/or sweeps, the user and expert profiles 24 and 26 may be updated accordingly.

At act 40, the session between the expert and user is terminated.

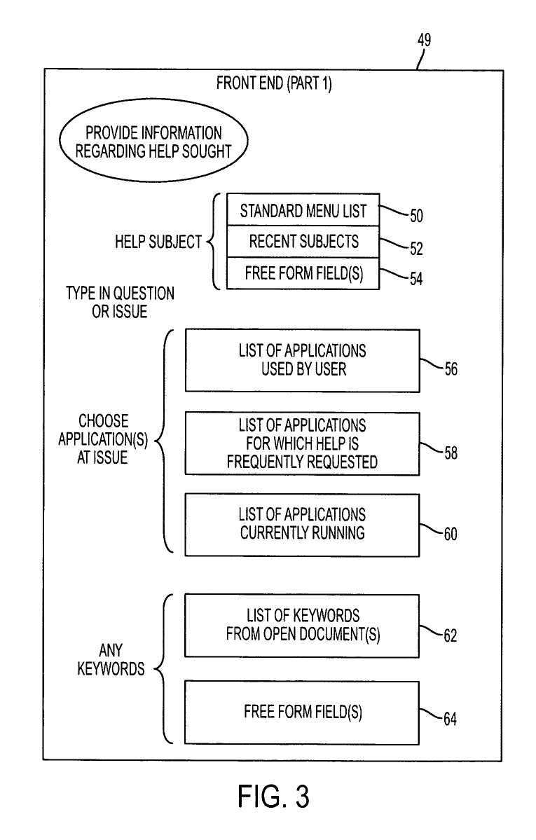

FIG. 3 is a schematic block diagram of a front end user interface which may be displayable on a user machine 14 as a result of the functionality provided by front end 22 through interface 13b (which, in the illustrated embodiment, is a web browser). The illustrated front end interface 49 includes a plurality of interfaces, which may be in the form of stored data (for example, in a file) and/or a graphical user interface. User interface 49 may be part of an individual work station, or a platform that includes one computer or a plurality of computers. The illustrated user interface may include an individual computer work station running an application program such as Microsoft Excel, Microsoft Access, or a web browser. A counterpart portion of the illustrated user interface may be provided in a separate computer to carry out certain functions of the user interface. For example, the user interface may include both a web browser client and a web page server on a separate machine.

The illustrated interface may include icons or otherwise manipulable graphical tools.

The front end interface 49, part one of which is shown in FIG. 3, is provided to provide information regarding the help sought by the user.

The interface includes graphical tools, which may include displayed information as well as fields for inputting information to a computer system. Those tools include help subject tools including a standard menu list 50 which, upon selection by the user, may present a standard menu of subjects that can be selected by the user. In addition, the help subject tools may include a recent subjects list 52, which can present, upon selection, a list of recent subjects requested by the user or by other users.

The user can interact with standard menu list 50 and recent subjects 52 to select the specific subjects for which help is sought by that user. In addition, free form field or fields 54 may be provided, in which a user can type in a specific question or issue.

A number of other graphical tools may be provided to allow a user to choose the application or applications at issue. Those tools may include a list 56 of applications used by the user, a list 58 of applications for which the help is frequently requested by that user, and a list 60 of applications currently running on the user machine for that user. In the illustrated embodiment, the user may simply select the items in the mentioned lists 56, 58 and 60, in order to provide input to the collaborative help engine 28. The collaborative help engine 28 then updates the user profile 26 accordingly, to indicate the selections made by the user.

Additional graphical tools include a list 62 of key words from open document or documents of the user on the user machine. In this case, a mechanism may be provided within collaborative help engine 28 to scan the user machine for any open documents, and to run an algorithm to select certain key words gathered from those open documents on the user machine. Those gathered key words may then be presented in list 62 of key words, to allow the user to select one or more of those key words as being relevant to the help request.

In addition, one or more free form fields 64 may be provided, in which the user can specify key words related to the help request.

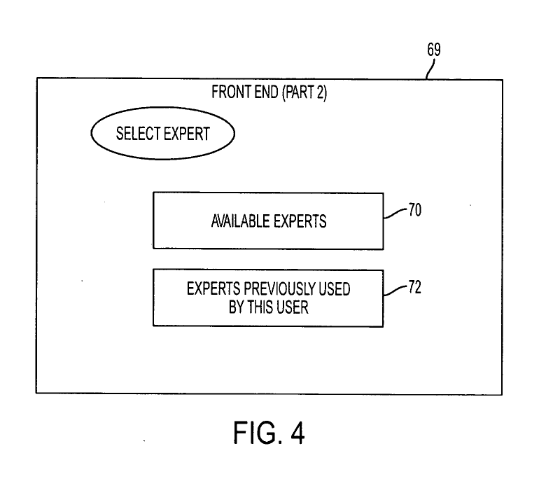

FIG. 4 shows a second part 69 of the front end portion of the illustrated collaborative help system. This part relates to the selection of an expert through the user machine interface. Accordingly, the second part interface 69 includes a graphical tool 70 for viewing the available experts that are available for the user's requests, as well as a tool 72 for viewing experts previously used by this user. The user can interact with the information viewable through tools 70 and 72 to select the expert for his or her help request.

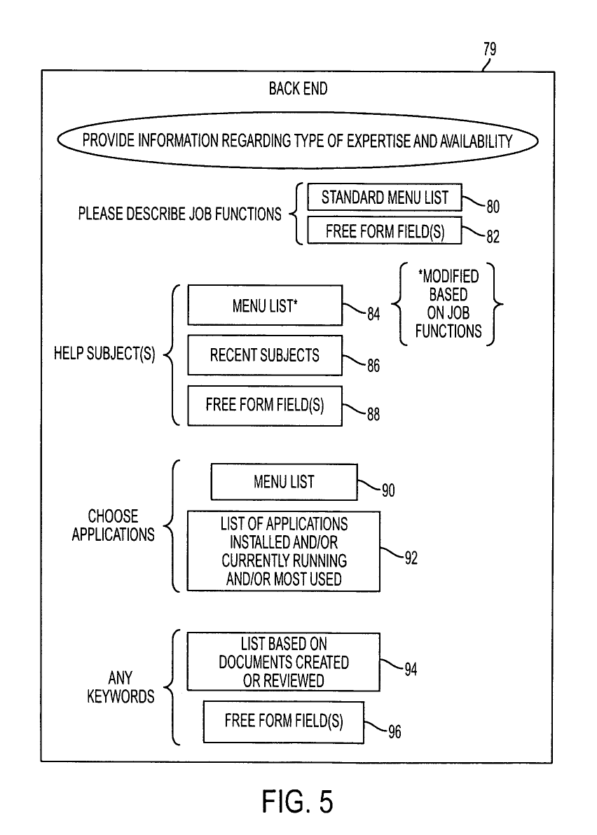

FIG. 5 shows a back end interface 79 which schematically presents an interface viewable by an expert via an expert machine 12. The illustrated back end interface 79 provides graphical tools to allow an expert to provide information regarding the type of expertise of the expert and the expert's availability. Accordingly, the illustrated interface 79 includes graphical tools for describing job functions of the expert, and for providing information regarding (i) help subjects for which the expert is willing to provide help or has expertise, (ii) applications the expert may choose for providing help to users, and (iii) any key words relevant to the expertise or the availability of that expert. The graphical tools in the illustrated embodiment include a standard menu list 80 and one or more free form fields 82. The standard menu list 80 may present a list of job functions from a standard menu, from which certain job functions can be selected by the expert through the use of a graphical user interface on the expert machine 12. Free form fields 82 may be used to allow the expert to type in job functions in a free form fashion.

The help subject or subjects for which an expert can provide help may be specified by the expert through the use of a menu list 84, selection of recent subjects 86, and the use of one or more free form fields 88. The menu list 84 may be configured so that it is modified based upon the job functions of the given expert as indicated through the use of graphical tools 80 and 82. For example, if the expert is in the marketing department, the subjects for which that expert will be presented through menu list 84 may be limited to a document processing program such as Microsoft PowerPoint and other publishing applications. Whereas, if the job description of the expert is in IT support, the types of applications listed in the menu list 84 may be include, for example, Windows XP. Recent subjects 86 present to the expert the recent subjects handled by that expert or by experts with similar job functions. One or more free form fields 88 allow the expert to indicate the subjects of interest or availability of that expert.

The specific applications for which the expert has expertise (or wishes to be available) may be specified by selecting among a preset menu list 90, or by choosing a list of applications 92 installed and/or currently running and/or most used by either the expert or by one or more users that are currently (or have in the past) used the collaborative help engine 28. This information, again as noted above, may be collected through the monitoring of input by users and experts, and/or by sweeping the expert and users machines, as described above.

Any key words relating to the expert's availability and credentials may be specified through the use of graphical tools including a list 94 of key words based upon documents created or reviewed by that expert, and/or through the use of free form fields 96. The key words that are acquired from documents created or reviewed by the expert may be determined by performing a sweep of the expert machine.

The claims as originally presented and as they may be amended, encompass variations, alternatives, modifications, improvements, equivalents and substantial equivalents of the embodiments and teachings disclosed herein, including those that are presently unforeseen or unappreciated, and that, for example, may arise from applicants/patentees and others.

What is claimed is:

1. Apparatus comprising:
a networking element to connect a user computer with an expert computer;
a changing set of help topics indicating topics requested by a user or provided by an expert; and
a help topic set modifier to modify the help topics in the changing set of help topics.

2. The apparatus according to claim 1, wherein the networking element includes a user computer network connection.

3. The apparatus according to claim 1, wherein the networking element includes a user computer web browser.

4. The apparatus according to claim 1, wherein the networking element includes an expert computer network connection.

5. The apparatus according to claim 1, wherein the networking element includes an expert computer web browser.

6. The apparatus according to claim 1, wherein the networking element includes a help server coupled to the user computer and to the expert computer.

7. The apparatus according to claim 1, wherein the set of help topics includes a set of user help topics unique to a given user.

8. The apparatus according to claim 1, wherein the set of help topics includes a set of expert help topics unique to a given expert.

9. The apparatus according to claim 7, wherein the set of user help topics includes a list of applications.

10. The apparatus according to claim 8, wherein the set of expert help topics includes a list of applications.

11. The apparatus according to claim 1, wherein the set of help topics is stored in a memory of the user computer.

12. The apparatus according to claim 1, wherein the set of help topics is stored in a memory of the expert computer.

13. The apparatus according to claim 1, wherein the set of help topics is stored in expert and user profile databases of the help server connected to the user computer and to the expert computer.

14. The apparatus according to claim 1, wherein the help topic set modifier includes a prompt interface element to prompt a user, via a computer screen interface on the user computer, to input help topic information.

15. The apparatus according to claim 1, wherein the help topic set modifier includes a sweeper remote from the user computer to sweep the user computer to ascertain configuration information from the user computer.

16. The apparatus according to claim 15, wherein the sweeper includes a mechanism to sweep the user computer to ascertain applications installed and a frequency of use of the applications installed on the user computer.

17. The apparatus according to claim 1, wherein the help topic set modifier includes a sweeper remote from the expert computer to sweep the expert computer to ascertain configuration information from the expert computer.

18. The apparatus according to claim 17, wherein the sweeper includes a mechanism to ascertain applications installed and a frequency of use of the applications installed on the expert computer.

19. A method comprising:
connecting with a networking element a user computer with an expert computer;
providing a changing set of help topics indicating topics for which a user requests help or for which an expert provides help; and
modifying a help topic set in the changing set of help topics.

20. Machine-readable media including encoded data, the encoded data interoperable with a machine to cause:
connecting a user computer with an expert computer using a networking element;
providing a changing set of help topics indicating topics for which a user requests help or for which an expert provides help; and
modifying a help topic set in the changing set of help topics.
